(19) United States
(12) Patent Application Publication
(10) Pub. No.: US 2024/0390113 A1
(43) Pub. Date: Nov. 28, 2024

(54) Dental Braces

(71) Applicant: SHANGHAI NINTH PEOPLE'S HOSPITAL, SHANGHAI JIAOTONG UNIVERSITY SCHOOL OF MEDICINE, Shanghai (CN)

(72) Inventors: Chao LIU, Shanghai (CN); Bing FANG, Shanghai (CN); Qingling YOU, Shanghai (CN)

(73) Assignee: SHANGHAI NINTH PEOPLE'S HOSPITAL, SHANGHAI JIAOTONG UNIVERSITY SCHOOL OF MEDICINE, Shanghai (CN)

(21) Appl. No.: 18/693,535

(22) PCT Filed: Sep. 2, 2022
(86) PCT No.: PCT/CN2022/116655

§ 371 Date: Mar. 20, 2024

(30) Foreign Application Priority Data
Sep. 27, 2021 (CN) 202111135883.3

(51) Int. Cl. A61C 7/16

(52) U.S. Cl. CPC A61C 7/16

(57) ABSTRACT

A dental braces includes at least one fixing element attached to surfaces of multiple abnormal teeth and provided with a first connector, and an orthodontic element provided with a second connector adapted to the first connector, where the second connector is engaged with the first connector to form an interference fit, such that the orthodontic element is detachably connected to the fixing element; and an elastic force of the orthodontic element acts on the abnormal teeth to control movement of the abnormal teeth.

### CROSS-REFERENCE TO THE RELATED APPLICATIONS

This application is the national phase entry of International Application No. PCT/CN2022/116655, filed on Sep. 2, 2022, which is based upon and claims priority to Chinese Patent Application No. 202111135883.3, filed on Sep. 27, 2021, the entire contents of which are incorporated herein by reference.

### TECHNICAL FIELD

The present application relates to the technical field of orthodontics, and in particular to dental braces.

### BACKGROUND

With the improvement of people's living standards and the advancement of medical technology, people are becoming healthier and more confident. Most people believe that having neat teeth can make them more confident, but many people are troubled by crooked teeth caused by congenital or acquired factors. Crooked teeth affect facial aesthetics and can lead to a lack of confidence. Furthermore, crooked teeth can affect the health of the teeth and periodontium. Therefore, people with crooked teeth hope to correct their teeth through orthodontics.

Usually, dental braces are used for orthodontic treatment. Traditional dental braces are a combination of brackets and arch wires. After diagnosing and evaluating the patient's teeth, the doctor fixes the brackets on the patient's teeth and connects the arch wires through the brackets, thereby moving the teeth through the elastic restoring force of the arch wires. However, the traditional fixed dental braces have low aesthetics and poor comfort when worn, and their brackets are prone to be bit off when the patient eat, which will bring inconvenience to the patient's daily life.

With the improvement of people's living standards, more and more people choose to use invisible dental braces for orthodontic treatment. The invisible dental braces, which are made of a transparent material to make them invisible in appearance, completely cover the dental crowns and are fixed to the teeth. The invisible dental braces apply a rebound force generated through deformation on the entire crowns so as to move the teeth. Although the invisible dental braces increase the retention and orthodontic forces through the attachments bonded on the tooth surface, they rely more on complete coverage of the crowns. Compared with traditional fixed dental braces, customized invisible dental braces do not require metal wires to tighten the teeth or cause oral wear and discomfort, thereby reducing the pain to the patient. Another major feature that distinguishes invisible dental braces from the fixed dental braces is that the patient can remove the dental braces at any time, allowing the patient to eat normally and clean the teeth during treatment, thereby maintaining oral hygiene.

However, removing and wearing dental braces before and after eating cause inconvenience for adolescent patients with low compliance or adult patients who frequently dine out. For example, if a patient eats without removing the invisible dental braces that completely cover the crowns, food residue will remain between the dental braces and the teeth, affecting the health of the teeth and periodontium. If the coverage area of the invisible dental braces is reduced such that the dental braces only cover a small portion of the tooth surface and still allow patients to remove and wear the invisible dental braces freely, it can reduce the frequency of removing the invisible dental braces and highlight the advantages of the invisible dental braces. However, since the invisible dental braces achieve retention and force application by completely covering the crowns, reducing the coverage area will cause a great reduction in the retention force of the dental braces, making the dental braces easy to detach from the teeth and fail to control the teeth.

### SUMMARY

To solve most if not all of the above-mentioned technical problems, the present application provides dental braces. The dental braces include: at least one fixing element attached to surfaces of multiple abnormal teeth and provided with a first connector; and
an orthodontic element provided with a second connector adapted to the first connector, where the second connector is engaged with the first connector to form an interference fit, such that the orthodontic element is detachably connected to the fixing element; and
an elastic force of the orthodontic element acts on the abnormal teeth to control movement of the abnormal teeth.

Optionally, the orthodontic element is further provided with an accommodating chamber; and the second connector is located in the accommodating chamber, such that the accommodating chamber at least partially covers the fixing element.

Optionally, the accommodating chamber completely covers the fixing element.

Optionally, the accommodating chamber covers at least part of the abnormal teeth.

Optionally, the first connector is a groove; a cross-sectional width of the groove close to a bottom of the groove is greater than a cross-sectional width of the groove close to an opening of the groove; alternatively, a wall of the groove is provided with a rough surface; and alternatively, the wall of the groove is provided with multiple corrugations.

Optionally, the groove is provided with at least two recesses.

Optionally, the two recesses intersect.

Optionally, one of the two recesses has a depth greater than a depth of the other.

Optionally, the groove is at least partially curved.

Optionally, the orthodontic element is integrally formed by three-dimensional (3D) printing.

The embodiment of the present application utilizes the fixing element to fix the orthodontic element relative to the tooth. The fixing element is attached to the surface of the tooth, and the orthodontic element is engaged with the fixing element, enhancing the fixation of the orthodontic element to the tooth. The main body of the dental braces can be detachably connected at any time, making it easy to clean and improving the convenience of use. Compared to the prior art, the present application changes the retention method of the dental braces from full coverage retention to interference fit retention, reducing the coverage area of the dental braces on the crown without reducing the retention force. Meanwhile, the present application can provide targeted correction for individual teeth, without the need to completely cover all crowns with the dental braces, reducing material costs, facilitating the mounting by the doctor and the use by the patient, greatly improving the user experience.

### BRIEF DESCRIPTION OF THE DRAWINGS

To describe the embodiments of the present application more clearly, related drawings are described in brief below.

It can be understood that the drawings in the following description show merely some embodiments of the present application, and those of ordinary skill in the art may still derive other technical features and connection relationships from these drawings.

FIG. 1 is a schematic diagram of dental braces after mounting according to an embodiment of the present application;

FIG. 2 is another schematic diagram of the dental braces shown in FIG. 1;

FIG. 3 is a structural diagram of the dental braces covering a tooth partially according to an embodiment of the present application;

FIG. 4 is a structural diagram of the dental braces covering a tooth completely according to an embodiment of the present application;

FIG. 5 is a schematic diagram of a fixing element and an orthodontic element after mounting according to an embodiment of the present application;

FIG. 6 is a schematic diagram of the fixing element according to an embodiment of the present application; and

FIG. 7 is another schematic diagram of the fixing element according to an embodiment of the present application.

### REFERENCE NUMERALS

1. fixing element; 11. first connector; 12. recess; 2. orthodontic element; 21. second connector; 22. accommodating chamber; and 3. abnormal tooth.

### DETAILED DESCRIPTION OF THE EMBODIMENTS

The present application is described in detail below with reference to drawings.

The invisible dental braces completely cover the dental crowns and are fixed to the teeth. The invisible dental braces apply a rebound force generated through deformation on the entire crowns to move the teeth. Although the invisible dental braces increase the retention and orthodontic force through the attachments bonded on the tooth surface, they rely more on complete coverage of the crowns. If the patient eats without removing the invisible dental braces, due to the dental braces completely covering the crowns, food residue will remain between the dental braces and the teeth, affecting the health of the teeth and periodontium.

If the coverage area of the invisible dental braces is reduced such that the dental braces only cover a small portion of the tooth surface, it can reduce the frequency of removing the invisible dental braces and highlight the advantages of the invisible dental braces. However, since the invisible dental braces achieve retention and force application by completely covering the crowns, if the coverage area is reduced, the retention force of the dental braces will be greatly reduced, making it easy for the dental braces to detach from the teeth and fail to control the teeth.

In view of this, the embodiment of the present application proposes some structural forms of dental braces. The present application changes the retention method of the dental braces from full coverage retention to interference fit retention, reducing the coverage area of the dental braces on crowns. In addition, the present application can correct individual teeth without completely covering all crowns.

### First Embodiment

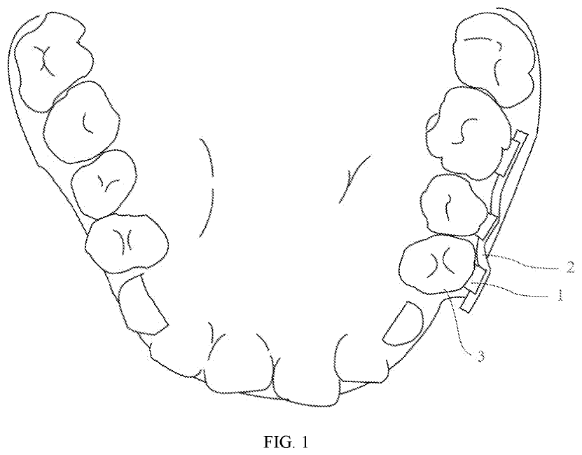

In view of this, the first embodiment of the present application proposes dental braces. As shown in FIG. 1, the dental braces typically include fixing element 1 and orthodontic element 2. The fixing element 1 is configured to connect abnormal teeth 3 to the orthodontic element 2. Through the fixing element 1, the orthodontic element 2 can perform targeted orthodontic treatment on the abnormal teeth 3. When the orthodontic element 2 is fixed to the abnormal teeth 3, an elastic force of the orthodontic element 2 acts on the abnormal teeth 3, causing the abnormal teeth 3 to be corrected. In addition, the orthodontic element is easy to be removed.

Specifically, as shown in FIGS. 1 to 4, the dental braces include at least one fixing element 1 and orthodontic element 2.

The at least one fixing element 1 is attached to surfaces of multiple abnormal teeth 3, and the fixing element 1 is provided with first connector 11.

The orthodontic element 2 is provided with second connector 21 adapted to the first connector 11. The second connector 21 is engaged with the first connector 11 to form an interference fit, such that the orthodontic element 2 is detachably connected to the fixing element 1.

An elastic force of the orthodontic element 2 acts on the abnormal teeth 3 to achieve orthodontic treatment of the abnormal teeth 3.

The fixing element 1 is attached to surfaces of the multiple abnormal teeth 3. It can be understood that there may be one or more abnormal teeth 3. One side of the fixing element 1 is attached to the surface of one or more abnormal teeth 3. The surface can be a surface of the abnormal tooth 3 close to lips or a surface of the abnormal tooth 3 close to a tongue. The specific attachment position is not limited, as long as the fixing element 1 can be attached. Of course, there may be multiple fixing elements 1 provided. For example, if the abnormal teeth 3 are not adjacent to each other, in order to avoid burdening the normal teeth 3 and causing discomfort to the patient, the multiple fixing elements 1 are spaced apart, or the orthodontic element 2 can cross some of the fixing elements 1 without being connected to them. That is, the fixing element 1 is only attached to the abnormal tooth 3, and the orthodontic element 2 is connected to the abnormal tooth 3 through the fixing element 1 to achieve an orthodontic purpose on the abnormal tooth 3. Through the connection and fixation method, the dental braces can perform orthodontic treatment on one or more abnormal teeth 3. When the multiple abnormal teeth 3 are not adjacent to each other, the dental braces do not need to cover normal teeth 3 between the multiple abnormal teeth 3, greatly improving the accuracy of correction and patient comfort.

The fixing element 1 is directly attached to the surface of the abnormal tooth 3 and in direct contact with the abnormal tooth 3. Therefore, it can be understood that an adhesive between the fixing element 1 and the abnormal tooth 3 cannot affect the tooth. For example, the adhesive between the fixing element 1 and the abnormal tooth 3 can be any one or a combination of more of non-mixed adhesive, a light-cured adhesive, a dual-paste chemically-cured adhesive, and a resin-reinforced glass ionomer.

Specifically, the orthodontic element 2 and the fixing element 1 are detachably connected. The fixing element 1 is provided with first connector 11, and one side of the orthodontic element 2 facing the fixing element 1 is provided with second connector 21 adapted to the first connector 11. The first connector forms an interference fit with the second connector, allowing for a detachable connection between the orthodontic element 2 and the fixing element 1. Furthermore, it can be understood that in order to achieve the detachable connection between the orthodontic element and the fixing element or the interference fit between the second connector 21 and the first connector 11, the second connector 21 or the first connector 11 may be made of an elastic material with a certain hardness. The orthodontic element 2 has a certain degree of elasticity. To ensure that a restoring force of the orthodontic element acts on the abnormal tooth 3, the orthodontic element 2 can also have a corresponding hardness. Through the interference fit, the main body of the dental braces can be detachably connected at any time, making it easy to clean and improving the convenience of use.

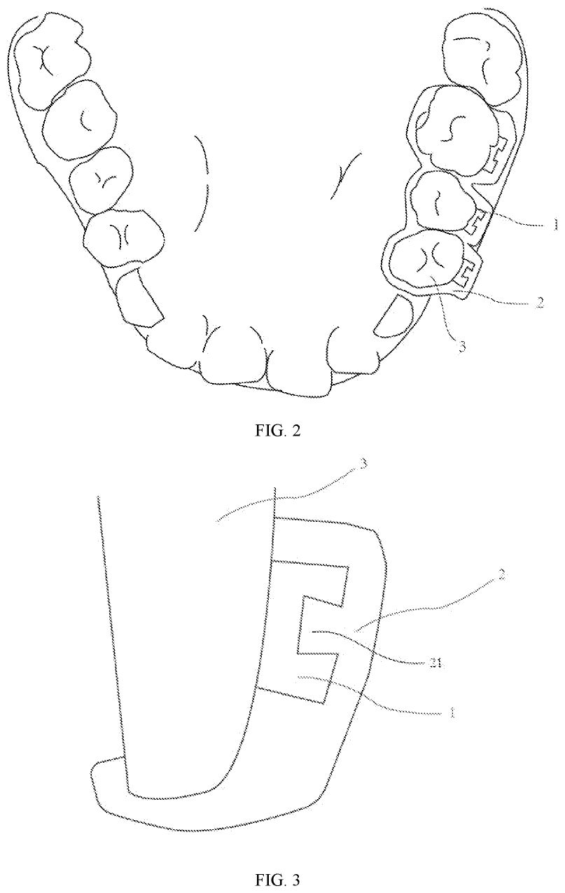

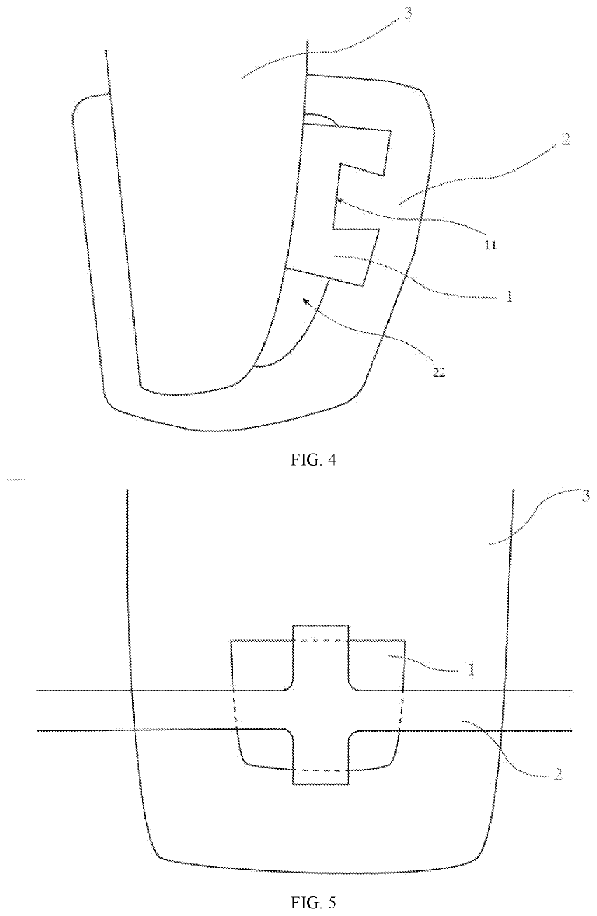

In some possible embodiments, as shown in FIG. 1, the orthodontic element 2 is only connected to the fixing element 1, making it convenient for a doctor to operate. In some other embodiments, as shown in FIG. 2, the orthodontic element 2 can also cover the fixing element 1, such that an orthodontic force of the orthodontic element 2 acts on a greater range and is more closely connected and matched with the fixing element 1. As shown in FIG. 3, the orthodontic element 2 can partially cover the abnormal tooth 3. As shown in FIG. 4, the orthodontic element 2 can also completely cover the abnormal tooth 3. By adjusting the degree of coverage of the orthodontic element 2, the present application balances the restoring force and the convenience of mounting and disassembling the orthodontic element 2, improving the orthodontic effect and patient's experience.

It can be understood that according to the number or position of the abnormal teeth or dentures, one or more fixing elements 1 can be provided for replacement. Similarly, one or more orthodontic elements 2 can be provided for replacement. For example, if there are two parts requiring correction in the oral cavity, one with two abnormal teeth and the other with three abnormal teeth, two sets of dental braces can be provided, greatly improving the patient's experience.

As shown in FIG. 4, the orthodontic element 2 is further provided with accommodating chamber 22, and the second connector 21 is located in the accommodating chamber 22, such that the accommodating chamber 22 at least partially covers the fixing element 1. The accommodating chamber 22 covers at least part of the abnormal teeth 3.

Furthermore, to ensure the stability of the orthodontic element 2 acting on the abnormal tooth 3, the orthodontic element 2 is provided with the accommodating chamber 22, and the second connector 21 is located in the accommodating chamber 22. In this way, when the second connector 21 is inserted into the first connector 11, the fixing element 1 is at least partially located in the accommodating chamber 22, enhancing the stability of the fixing element 1 and the orthodontic element 2. Meanwhile, the accommodating chamber 22 covers at least part of the abnormal teeth 3 to increase the contact area between the orthodontic element 2 and the abnormal tooth 3, thereby improving the orthodontic accuracy of the abnormal tooth 3. Of course, in order to further enhance the stability and accuracy of the connection between the orthodontic element 2 and the abnormal tooth 3, the accommodating chamber 22 can completely cover an outer side of the abnormal tooth 3, allowing for rapid repair and orthodontic treatment of the abnormal tooth 3.

Specifically, the accommodating chamber 22 is adapted with the abnormal tooth 3 in terms of shape and size. In practical applications, the shape of the accommodating chamber 22 can be designed according to the shape of the abnormal tooth 3. That is, when the fixing element 1 is attached to an outer surface of the abnormal tooth 3 (the side facing the lips), the shape of the side of the accommodating chamber 22 facing the abnormal tooth 3 corresponds to the shape of the outer surface of the abnormal tooth 3. When the fixing element 1 is attached to an inner surface of the abnormal tooth 3 (the side facing the tongue), the shape of the accommodating chamber 22 facing the abnormal tooth 3 corresponds to the shape of the inner surface of the abnormal tooth 3. In addition, the size of the accommodating chamber 22 can be slightly greater than the size of the abnormal tooth 3. Therefore, when the accommodating chamber 22 of the orthodontic element covers the abnormal tooth 3, the inner surface of the accommodating chamber 22 contacts and adheres to the outer or inner surface of the abnormal tooth 3. Furthermore, the second connector 21 in the accommodating chamber 22 is fitted to the abnormal tooth 3 to facilitate the operation of the dental braces by the doctor.

In a possible embodiment, the orthodontic element 2 is made of a transparent material. When orthodontic treatment is performed on the abnormal tooth 3, the orthodontic element 2 made of the transparent material avoids affecting the aesthetics of the abnormal tooth 3.

In some possible embodiments, as shown in FIGS. 4 to 7, the first connector may be a groove. A cross-sectional width of the groove close to a bottom of the groove is greater than a cross-sectional width of the groove close to an opening of the groove. Alternatively, a wall of the groove is provided with a rough surface. Alternatively, the wall of the groove is provided with multiple corrugations.

The cross-sectional width of the groove close to the bottom is greater than the cross-sectional width of the groove close to the opening. In other words, the cross-sectional width of the groove gradually increases from the opening to the bottom. For example, a cross-section of the groove is trapezoidal.

It can be understood that in this embodiment, a direction of the cross-section of the groove refers to a width direction of the groove (a tangent direction of a short side of the groove, the same below).

The cross-sectional width of the groove close to the bottom is greater than the cross-sectional width of the groove close to the opening. In other words, a sudden change occurs in the cross-sectional width of the groove from the opening to the bottom, causing the cross-sectional width at the bottom to be greater than the cross-sectional width at the opening. For example, the cross-section of the groove is in a “T” shape.

Correspondingly, the first connector 11 is a groove, and the second connector 21 is a protrusion adapted to the groove. A cross-sectional width of the protrusion at an end facing the bottom of the groove is greater than a cross-sectional width of the protrusion at the opening of the groove. A cross-sectional width of the protrusion at an end facing away from the opening of the groove can be set as needed. Alternatively, the first connector 11 is a protrusion and the second connector 21 is a groove, which can also achieve the technical purpose of the present application.

Along a direction perpendicular to the cross-section of the groove, the cross-section of the groove can also be in a “straight” shape, a circular ring shape, a sector shape, an “O” shape, or a “cross” shape, etc. That is, the specific structure of the groove is not limited as long as the interference fit between the groove and the protrusion of the orthodontic element can be achieved.

In this embodiment, the cross-sectional width at the bottom of the groove is greater than the cross-sectional width at the opening of the groove. The small opening of the groove can play a fixing role on the protrusion (of the orthodontic element 2), avoiding easy separation between the protrusion and the groove. In addition, the wall of the groove is provided with a rough surface or multiple corrugations to increase the friction force between the protrusion and the fixing element 1, further enhancing the firmness of the orthodontic element 2 and the fixing element 1. The design can prevent the orthodontic element 2 from detaching from the fixing element 1, thereby avoiding affecting the dental braces' orthodontic treatment on the abnormal tooth 3. The outer surface of the protrusion can also be provided with small bumps to increase the friction force when the groove and the protrusion are engaged with each other, preventing the fixing element 1 from detaching from the orthodontic element 2.

In addition, in other embodiments, the first connector 11 may be a protrusion and the second connector 21 may be a groove to achieve an interference fit.

In this embodiment, the orthodontic element 2 is integrally formed by three-dimensional (3D) printing.

The dental braces in the prior art are usually made of a plaster model of a 3D abnormal teeth 3 impression fabricated based on abnormal teeth 3 of the patient. The abnormal tooth 3 is cut open using a small jeweler's saw or rotary cutting tool, and the gypsum abnormal tooth 3 is repositioned in a better and straighter desired arrangement. The abnormal tooth 3 is retained in the new arrangement using dental wax, thereby changing the plaster model of the abnormal tooth 3. The repositioned model of the abnormal tooth 3 provides the manufacturing basis for the dental braces. The material of the dental braces needs to be elastic to provide energy to move the abnormal tooth 3 from its original position to the new aligned position. In each step of the orthodontic element 2, using plaster and wax for manual placement of the abnormal tooth 3 will make the manufacturing of the dental braces difficult and cumbersome. The orthodontic element 2 can be integrally formed by 3D printing, which is simpler and more convenient than traditional manufacturing methods.

In other embodiments, the orthodontic element 2 may be injection-molded. Injection molding is a common process, which will not be further elaborated herein. The orthodontic element 2 can also be formed by casting. Casting is also a common process, which will not be further elaborated herein.

Similarly, the fixing element 1 can be integrally formed by 3D printing or formed by casting, which will not be elaborated herein.

This embodiment further provides an operational process for the dental braces in a specific orthodontic process.
1. The dental braces are tailored for a patient. According to the above-mentioned production method of the dental braces, the fixing element 1 and the orthodontic element 2 matched with the patient's abnormal tooth 3 are made by intraoral scanning and 3D printing, and a computer-assisted positioning adhesive guide is made. Meanwhile, based on an orthodontic goal, a treatment plan is designed and tooth movement is simulated in steps to customize the orthodontic element 2 for each step.
2. As shown in FIG. 2, the fixing element 2 is attached to the outer surface of the abnormal tooth 3 through the computer-assisted positioning adhesive guide. The orthodontic element 2 covers the abnormal tooth 3, and forms an interference fit with the fixing element 2, thereby completing the mounting of the dental braces. In the subsequent treatment process, the patient can replace the orthodontic element according to the specific step.
3. During use, the patient can easily mount and disassemble the orthodontic element 2 of the dental braces as needed, which is very convenient. Specifically, the patient can regularly disassemble the orthodontic element 2 to clean the fixing element 1 and the orthodontic element 2. The fixing element 1 can be cleaned by normal brushing action.

The embodiment of the present application utilizes the fixing element to fix the orthodontic element 2 relative to the tooth. The fixing element 1 is attached to the surface of the tooth, and the orthodontic element 2 is engaged with the fixing element 1, enhancing the fixation of the orthodontic element 2 to the tooth. The main body of the dental braces can be detachably connected at any time, making it easy to clean and improving the convenience of use.

Compared to the prior art, the present application changes the retention method of the dental braces from full coverage retention to interference fit retention, reducing the coverage area of the dental braces on the crown without reducing the retention force. Meanwhile, the present application can provide targeted correction for individual teeth, without the need to completely cover all crowns with the dental braces, reducing material costs, facilitating the mounting by the doctor and the use by the patient, greatly improving the user experience.

### Second Embodiment

In the prior art, doctors apply dental adhesive to the back of the dental braces and fix the dental braces to the surfaces of the teeth. If there is a deviation in the mounting angle of the dental braces, it will reduce the traction effect of the dental braces, thereby delaying the orthodontic treatment cycle. The mounting process of existing dental braces is complex and inconvenient for patients, causing troubles for both patients and doctors. To solve the above problems, improved dental braces are needed, which can provide targeted correction for the abnormal teeth and are easy to mount.

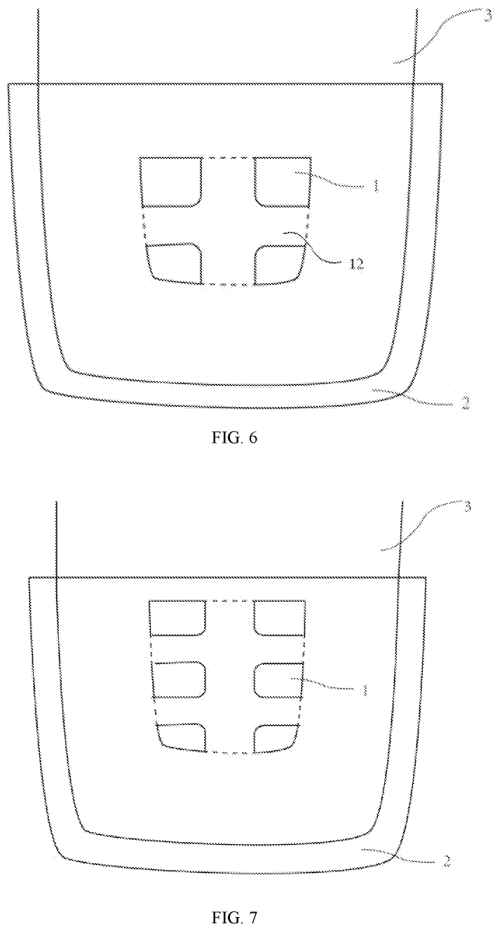

In view of this, the second embodiment of the present application makes improvements to the dental braces of the first embodiment. As shown in FIGS. 6 and 7, in this embodiment, the first connector 11 is a groove. The groove is provided with at least two recesses 12. The two recesses 12 intersect. One of the two recesses 12 has a depth greater than a depth of the other.

The fixing element 1 is provided with first connector 11, and one side of the orthodontic element 2 facing the fixing element 1 is provided with second connector 21 adapted to the first connector 11. The first connector forms an interference fit with the second connector, allowing for a detachable connection between the orthodontic element 2 and the fixing element 1. It can be understood that to achieve the detachable connection between the orthodontic element and the fixing element or the interference fit between the second connector 21 and the first connector 11, the second connector 21 needs to be made of an elastic material with a certain hardness, and the size of the second connector 21 gradually increases from the accommodating chamber 22 to the abnormal tooth 3. Of course, the orthodontic element 2 covers the abnormal tooth 3 for orthodontic treatment of the abnormal tooth 3. Therefore, the orthodontic element 2 has a certain elastic force and corresponding hardness to ensure that the elastic force acts on the abnormal tooth 3.

It should be noted that there are at least two recesses 12 inside the groove to increase the engagement tightness between the first connector 11 and the second connector 21. Due to the presence of the at least two recesses 12 inside the first connector 11, it is possible to prevent the fixing element 1 and the orthodontic element 2 from becoming loose or even detached from each other.

It can be understood that the second connector 21 of the orthodontic element 2 is adapted to the first connector 11. When there are at least two recesses 12 inside the first connector 11, the second connector 21 is provided with at least two raised parts to engage the first connector 11 and the second connector 21. The recess 12 can be located on a side wall of the first connector 11 or at a bottom of the first connector 11. When there are two recesses 12, the cross-section of the first connector 11 is in a “cross” or “X” shape. Of course, there can also be three, four, or five recesses 12. For example, when there are four recesses, the four recesses intersect, and the cross-section of the first connector 11 can be in a “#” shape.

In addition, the depth of one recess 12 is greater than a depth of the other recess 12, such that the fixing element 1 and the orthodontic element 2 can be easily disassembled in the later stage. For example, when there are two recesses 12, namely transverse recess 12 and longitudinal recess 12, the depth of the longitudinal recess 12 is greater than that of the transverse recess 12. The orthodontic element 2 is provided with a transverse second connector and a longitudinal second connector. The orthopedic element 2 applies a transverse force to the abnormal tooth 3, and under the elastic action of the orthodontic element 2, the orthodontic element 2 contracts transversely to compress the longitudinal second connector. If the depth of the longitudinal recess 12 is less than or equal to the depth of the transverse recess 12, the longitudinal second connector of the orthodontic element 2 will closely abut with the transverse recess 12, making it difficult to disassemble the orthodontic element 2 and the fixing element in the later stage. Of course, in other embodiments, when there are two recesses 12, namely the transverse recess 12 and the longitudinal recess 12, the depth of the transverse recess 12 can also be greater than that of the longitudinal recess 12. Specifically, this requires selection or adjustment based on the actual abnormal tooth 3.

Similarly, the bottom of the groove of the first connector 11 is greater than the part close to the opening of the groove. The small opening of the groove can serve as a fixing role for the second connector 21 (of the orthodontic element 2), avoiding easy separation between the second connector 21 and the first connector 11. In addition, the wall of the groove of the first connector 11 is provided with a rough surface, or the wall of the groove of the first connector 11 is provided with multiple corrugations, further increasing the firmness of the orthodontic element 2 and the fixing element 1. The fixing element 1 is usually made of a transparent material. Of course, it can also be made of other materials, such as stainless steel. The material of the fixing element is selected according to actual needs, which is not limited herein. The orthopedic element 2 is made of a transparent flexible material. In this way, the first connector 11 (of the fixing element 1) forms an interference fit with the second connector 21 (of the orthodontic element 2) to ensure their connection stability.

Obviously, if the first connector 11 is a protrusion and the second connector 21 is a groove, the technical purpose of the present application can also be achieved.

The embodiment of the present application utilizes the fixing element to fix the orthodontic element relative to the tooth. The fixing element is attached to the surface of the tooth, and the orthodontic element is engaged with the fixing element, enhancing the fixation of the orthodontic element to the tooth. The main body of the dental braces can be detachably connected at any time, making it easy to clean and improving the convenience of use.

### Third Embodiment

The third embodiment of the present application provides dental braces. The third embodiment is a further improvement of the first embodiment, which enhances the connection stability between the fixing element 1 and the orthodontic element 2. The fixing element 1 and the orthodontic element 2 are hard to detach due to non-human factors.

In this embodiment, the fixing element 1 is provided with the first connector 11. The orthodontic element 2 is provided with the second connector 21 adapted to the first connector 11. When the second connector 21 of the orthodontic element 2 is inserted into the first connector 11 and forms an interference fit with the first connector, the orthodontic element 2 is detachably connected to the fixing element 1. The cross-sectional width of the first connector 11 close to the bottom of the groove is greater than that of the first connector close to the opening of the groove, and the first connector 11 is at least partially curved.

It is worth mentioning that the first connector 11 of the fixing element 1 is at least partially curved. In this embodiment, the first connector 11 is at least partially curved, that is, a side wall of the first connector 11 is at least partially curved. Since the second connector 21 and the first connector 11 are adapted and the second connector 21 is inserted into the first connector 11 and forms an interference fit with the first connector, the second connector 21 is provided with a protruding curved segment corresponding to the curved portion of the first connector 11. The design increases the contact area between the first connector 11 and the second connector 21, thereby enhancing the connection stability the between the first connector and the second connector. Of course, it should be noted that there can be a gap between the fixing element 1 and the orthodontic element 2, that is, there can be a gap between the abnormal tooth 3 and the orthodontic element 2, as long as the abnormal tooth 3 and the orthodontic element 2 can be fixed to each other.

Finally, it should be noted that in order to make the present application better understood, many technical details are proposed in the embodiments of the present application. However, even without these technical details and various changes and modifications made based on the above embodiments, the technical solutions claimed by the present application can still be achieved. Therefore, in practical applications, various changes can be made to the above embodiments in terms of form and details without departing from the spirit and scope of the present application.

What is claimed is:

1. Dental braces, comprising:
at least one fixing element attached to surfaces of a plurality of abnormal teeth and provided with a first connector; and
an orthodontic element provided with a second connector adapted to the first connector, wherein the second connector is engaged with the first connector to form an interference fit, wherein the orthodontic element is detachably connected to the at least one fixing element; and
an elastic force of the orthodontic element acts on the plurality of abnormal teeth to control movement of the plurality of abnormal teeth.

2. The dental braces according to claim 1, wherein the orthodontic element is further provided with an accommodating chamber; and the second connector is located in the accommodating chamber, wherein the accommodating chamber at least partially covers the at least one fixing element.

3. The dental braces according to claim 2, wherein the accommodating chamber completely covers the at least one fixing element.

4. The dental braces according to claim 3, wherein the accommodating chamber covers at least part of the plurality of abnormal teeth.

5. The dental braces according to claim 1, wherein at least one of the first connector and the second connector is a groove; and a cross-sectional width of the groove adjacent to a bottom of the groove is greater than a cross-sectional width of the groove adjacent to an opening of the groove; or
a wall of the first connector is provided with a rough surface; or
the wall of the first connector is provided with a plurality of corrugations.

6. The dental braces according to claim 5, wherein the groove is provided with at least two recesses.

7. The dental braces according to claim 6, wherein the at least two recesses intersect.

8. The dental braces according to claim 6, wherein a first one of the at least two recesses has a depth greater than a depth of a second one of the at least two recesses.

9. The dental braces according to claim 5, wherein the groove is at least partially curved.

10. The dental braces according to claim 1, wherein the orthodontic element is integrally formed by three-dimensional (3D) printing.
